(19) United States
(12) Patent Application Publication
(10) Pub. No.: US 2026/0225504 A1
(43) Pub. Date: Aug. 6, 2026

(54) AN ADJUSTABLE HANDLE FOR AN INFANT CARRIER

(71) Applicant: Tetro Ltd., Quarry Bay (HK)

(72) Inventor: Ilan BEN MEIR, Ra'anana (IL)

(21) Appl. No.: 19/149,973

(22) PCT Filed: Feb. 1, 2024
(86) PCT No.: PCT/IL2024/050126

§ 371 Date: Jul. 22, 2025

(30) Foreign Application Priority Data
Feb. 6, 2023 (IL) 300449

(51) Int. Cl. B60N 2/28; A47D 13/02

(52) U.S. Cl. CPC B60N 2/2845; A47D 13/027; B60N 2/2827

(57) ABSTRACT

An infant carrier including: a seat comprising a seating portion, side walls extending upwards from the seating portion, and a back rest; a handle comprising two elongate arms, each arm having distal and proximal; and a grasping portion extending between the distal ends; pivot connections via which the proximal ends are pivotably mounted to the side walls so as to enable pivoting of the arms together with the grasping portion about a handle pivoting axis; the handle pivotable between at least a first position and a second position which differ in an angle formed by the elongate arms with a vertical reference plane comprising the pivoting axis; and a distance adjusting mechanism operably connected to each so that pivoting of the arms actuates the mechanism to change a distance between the distal end of each of the elongate arms and the handle pivoting axis.

### TECHNOLOGICAL FIELD

The presently disclosed subject matter is in the field of car safety and relates to an infant carrier having a handle, the infant carrier configured to constitute a part of a safety car seat. More specifically, the presently disclosed subject matter relates to a handle of an infant carrier which is adjustable between at least two positions.

### BACKGROUND

WO0045677A1 discloses a baby carrier comprising a carrying frame which has a handle part and lateral limbs. The carrying frame is mounted on the baby carrier by means of a connecting device such that the frame can pivot around a transversal axis of the carrier. To improve the carrying comfort of and to reduce the danger of injury to even the smallest child placed in the baby carrier, the radial distance between the handle part of the carrying frame and of the connecting device can be adjusted.

US 2007/0278756 discloses an infant car seat with two handles. The infant car seat has a curved bottom surface for rocking the seat. One handle is pivotally attached to the seat and is adapted to have a plurality of locked positions. Wheels are positioned along the curved bottom surface between the floor contact area and the foot end of the seat. The wheels are shaped and positioned to allow the seat to be rocked and to allow the seat to be propelled by rolling on the wheels. The other handle extends from the handle and may be pivoted such that a user grasping the secondary handle may lift the bottom surface of the seat off the floor while maintaining contact between the wheels and the floor.

GB 2451830 discloses a child car seat for infants includes a seat structure securable to a vehicle seat, with wheels turning about a wheel axle directly mounted to the seat. The wheels may be located at one end of the seat, or in a recess. The apparatus may include an extendable U-shaped handle mounted about pivots on each side of the seat, used to tip the seat onto the wheels to roll along the ground, or for carrying the seat. The handle may be detachable.

US 2010/0019557 to Gray et al. discloses a car seat, which can be converted into a stroller by extending a stroller handle and tilting the car seat backwards until a pair of wheels contacts the ground. A pair of wheels is placed on the back surface of the car seat to convert the car seat into a stroller, if and when necessary. and a separate handle will be used to enable the user to tilt the car seat so that the device can be rolled.

DE 10108415 to Gosdin discloses a baby seat for use as a transport seat and/or for use as a stroller, which comprises a shell-like receiving element, and at least one arm fixedly arranged on the receiving element, the arm comprising a wheel at an end thereof.

### GENERAL DESCRIPTION

According to the presently disclosed subject matter, there is provided, for use in an infant carrier, a pivotable handle associated with a distance adjusting mechanism operable to change a distance between its grasping portion and a handle pivoting axis.

The infant carrier with the handle can be configured to constitute a part of a safety car seat and can thus comprise a seat shaped to accommodate an infant; the seat comprising a seating portion, side walls extending upwards from the seating portion, and a back rest.

The handle can be of a kind comprising, in addition to the above grasping portion two elongate arms, each arm having a distal end and a proximal end, with a proximal portion of the arm defined adjacent the proximal end and a distal portion of the arm defined adjacent the distal end; the grasping portion extending between the distal ends of the arms.

The infant carrier can further comprise pivot connections via which the proximal ends of the arms are pivotably mounted to said side walls so as to enable pivoting of the arms together with the grasping portion about a handle pivoting axis.

Thus, the above handle can be pivotable between at least a first position and a second position which differ in an angle formed by at least the proximal portion of each of the elongate arms with a vertical reference plane comprising the handle pivoting axis; and the distance adjusting mechanism can be operably connected to each of the elongate arms and located, at least in part, at the corresponding pivot connection so that pivoting of the arms about said pivot connection actuates said mechanism to change a distance between the distal end of each of said elongate arms and said handle pivoting axis. Optionally, the angle in the first position can be smaller than in the second position.

The first position of the handle can be defined as a carrying position thereof and the second position of the handle can be defined as a storage position. At the first position of the handle the distance between the distal end of each of the elongate arms and its corresponding pivot connection can at least not exceed a distance between the reference plane and an area of the backrest most remote from the reference plane.

At the first position of the handle the distance between the distal end of each of the elongate arms and its corresponding pivot connection can at least not exceed a distance between the reference plane and an area of the backrest most remote from the reference plane.

The grasping portion of the handle, at least when in the second position, can be spaced from the vertical reference plane to a distance greater than a distance between the back rest and the reference plane. Optionally, at the second position, the distance between the distal end of each of the elongate arms and its corresponding pivot joint is greater than at the first position.

The distance adjusting mechanism can have one or more of at least the following features in any combination thereof:
the pivoting and the change of the distance take place simultaneously;
the distance adjusting mechanism can be configured to change the distance incrementally and so that the distance changes with the change of the angle;
the distance adjusting mechanism can be configured so that the change in distance is actuated for at least a portion of a total angle along which the handle is pivoted;
the distance adjusting mechanism can be actuatable by a single pivoting movement of the handle;
the elongate arm can be configured for maintaining its shape and contour during the adjustment;
the distance adjustment mechanism can be automatically actuatable by pivoting of the arm at the pivot connection; for example, the distance adjustment mechanism can be actuatable by the user pivoting the arms by pushing or pulling of the handle in the frontwards or rearwards direction of the seat, thereby simultaneously causing the distance between the handle grasping portion and the pivot connection to lengthen or shorten;
the distance adjusting mechanism can be operable to transfer pivoting motion of the elongate arm at the pivot connection into linear movement of at least a part of the elongate arm; in one example, the arm can have a telescopic structure in which one part of the arm is linearly moveable relative to the other part of the arm; in another example, the arm itself can be linearly moveable at least indirectly by the movement adjustment mechanism.

The infant carrier can further comprise a lock mechanism for restricting pivoting of the handle at least at the first position and/or at the second position. In this case, the lock mechanism can be configured to be released when pivoting of the handle is desired.

In an infant carrier having any of the above features, the distance adjusting mechanism can comprise a seat connection component positioned such that the handle pivot axis extends through its center, and at least one handle connection component which is in direct or indirect engagement with the seat connection component for transferring pivoting motion of the handle into movement of at least a part of the elongate arm associated with the handle connection component. In this case, the distance adjusting mechanism can comprise one or more of at least the following features in any combination thereof:
the seat connection component can be fixed in position and be free of an ability to pivot or rotate;
the seat connection component can be at least partially rounded so that at least the proximal portion of the elongate arm (i.e. a housing of the elongate arm) is rotatably positioned around the seat connection component;
the handle connection component can be coupled to the housing of the elongate arm at least at the proximal portion such that when the elongate arm is pivoted, the handle connection component is carried along with the housing and is moved relative to the fixed seat connection component;
the handle connection component can be constituted by an element other than the elongate arm itself; in particular, the handle connection component can be formed or connected inside a housing of the elongate arm.

The above distance adjusting mechanism can further comprise one or both of the following features:
the seat connection component can be formed as an at least partially toothed element and the handle connection component can be formed as an at least partially toothed element, the at least partially toothed elements being at least partially meshed with each other;
the handle connection component can be rotatable about a handle connection component pivoting axis which is different than the handle pivoting axis, the plurality of teeth of the handle connection component being located at different distances from the handle connection component pivoting axis.

In a handle for an infant carrier having any of the above features, the proximal portion and the distal portion of each elongate arm can be integrally formed as a single unit. Alternatively, the proximal portion and the distal portion of each elongate arm constitute two different portions. Optionally, in such arrangement, the proximal portion and the distal portion are arranged so that pivoting of the elongate arm changes their position with respect to each other; further optionally in such arrangement, the proximal portion and the distal portion are telescopic, with the distal portion being connected to the grasping portion and the proximal portion holding at least a part of the distance adjusting mechanism.

The infant carrier having any of the above features can constitute a part of a kit which can further comprise a base mountable onto a car seat, the infant carrier configured to be mounted onto said base. In this case, the base and the infant carrier, inclusive of the handle at both the first and second positions and in between said positions, can be configured to fit within a predetermined enveloping volume whose maximal height is smaller than that which the base and the carrier with the handle would have if the distance between the grasping portion of the handle and the pivoting connection in the first position of the handle would be equal to that in the second position of the handle. Such predetermined enveloping volume, for example, can be as defined by Regulation No. 129 (“Uniform provisions concerning the approval of enhanced Child Restraint Systems used on board of motor vehicles (ECRS), 2014”.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic side view illustration of an infant carrier when it constitutes a part of a safety car seat, in accordance with an example of the presently disclosed subject matter;

FIG. 2 is a schematic side view illustration of a handle of an infant carrier, in accordance with an example of the presently disclosed subject matter;

FIG. 3 is a schematic illustration of a telescopic structure which can be used in a in a handle, in accordance with the presently disclosed subject matter;

FIGS. 4A-B are schematic illustrations of distance adjusting mechanisms which can be used with a handle, in accordance with the presently disclosed subject matter;

FIGS. 5A-C are longitudinal cross-sectional views of a handle including a distance adjusting mechanism of the kind described in FIG. 4A, in accordance with a further example of the presently disclosed subject matter, in three different states of the mechanism, respectively;

FIG. 6 is a cross-sectional view of a handle comprising a lock mechanism, in accordance with a further example of the presently disclosed subject matter;

FIGS. 7A-B are exploded views of a proximal portion of a handle including a distance adjusting mechanism of the kind shown in FIG. 4A, and a lock mechanism of the kind shown in FIG. 6, in accordance with a further example of the presently disclosed subject matter;

FIGS. 8A-C are longitudinal cross-sectional views of a handle comprising a distance adjusting mechanism of the kind shown in FIG. 4B, in accordance with a further example the presently disclosed subject matter, in three different states of the mechanism, respectively;

FIG. 9A is a perspective view of a proximal portion of a handle comprising a lock mechanism, in accordance with a further example of the presently disclosed subject matter;

FIG. 9B is a side view of an infant carrier comprising a handle of the kind shown in FIG. 9A, in accordance with a further example of the presently disclosed subject matter;

FIG. 9C is a cross-sectional view of a proximal portion of a handle comprising a lock mechanism of the kind shown in FIG. 9A, in accordance with a further example of the presently disclosed subject matter;

FIG. 10A is an exploded view of a proximal portion of a handle without an external cover of a housing thereof, the handle comprising a distance adjusting mechanism of the kind shown in FIG. 4B, in accordance with a further example of the presently disclosed subject matter;

FIGS. 10B and 10C are exploded views of the proximal portion of a handle shown in FIG. 10A including the external cover of the housing; and

FIG. 11 is a perspective view of an infant carrier frame with a seat connection component via which a handle can be connected to the frame, in accordance with an example of the presently disclosed subject matter.

### DETAILED DESCRIPTION OF EMBODIMENTS

An infant carrier according to the presently disclosed subject matter can be detachably connectable to a base which is mounted/able on a car seat and may be affixed to the car seat by any suitable mechanism, such as by “Isofix” anchoring. The infant carrier comprises a seat shaped and sized to accommodate an infant, and a handle attached thereto for holding the carrier (e.g. when the carrier is used outside the car), for placing the carrier onto its base, for lifting the carrier from the base, and as such. The carrier seat comprises a seating portion, opposing side walls extending upwards from the seating portion, and a back rest.

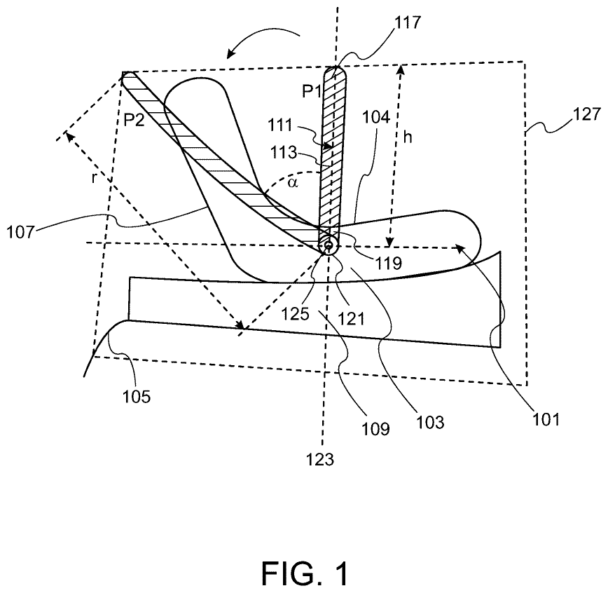

Reference is made to FIG. 1, a schematic side view illustration of an infant carrier when it constitutes a part of a safety car seat, in accordance with an example of the presently disclosed subject matter.

The carrier, designated as 101, comprises a seat 103 configured to accommodate an infant, and a handle 111 attached thereto. Seat 103 comprises a seating portion 104, opposing side walls (for clarity, not referenced in this figure), and a back rest 107. The side walls of the seat extend upwardly from the seating portion forming therewith an at least partially concave area or suitable curvature for the infant to be seated in. Optionally, restraining means such as belts, buckles, latches etc. are provided for holding the infant to the seat.

As shown, carrier 101 can be detachably connected to a base 109, which is mounted on a car seat and may be affixed to the car seat, such as by “Isofix” anchoring 105.

In the present example, handle 111 includes two opposing elongate arms 113, and a grasping portion (not shown at this side view) which extends between distal ends 117 of the arms, bridging above and across the seat portion. A proximal end 119 of each of the elongate arms is connected to the seat, for example to the seat portion, such as to the side wall of the seat. Each of the elongate arms is connected to the corresponding side wall of the seat such that the arms are configured to pivot along with the grasping portion of the handle, changing a position of the handle relative to the seat.

In some embodiments, the elongate arms and the grasping portion can be unitary, for example, formed as a single piece. Alternatively, the elongate arms and the grasping portion can be modular parts, and the grasping portion can be coupled to the distal ends of the two elongate arms by any suitable attachment or mounting which maintains a firm engagement between the two, such that a force applied onto the grasping portion (e.g. by the user's hand(s)) would in turn move (e.g. pivot) the elongate arms.

In general, each of the proximal ends of the elongate arms of the handle can be connected to the side wall of the seat by a coupling which allows pivoting of the handle about a pivot axis. The pivot axis can pass through opposing pivot points of the two elongate arms respectively.

When the elongate arms pivot about the pivot axis, the arms and the grasping portion extending between them move altogether relative to the seat. The handle can be pivoted between multiple positions, each position characterized by a different angle between the handle elongate arms and a vertical reference plane comprising the pivot axis. The positions of the handle can include at least two extreme positions such as a first, carrying position in which the handle is in an upright position suitable for manual engagement by a user, and a second, storage position in which the handle is at a reclined position, for example, with the grasping portion extending behind the back rest of the seat.

In the present example, the attachment of elongate arm proximal end 119 to the side wall of the seat comprises a pivot connection 121, which enables handle 111 to move between positions that differ from each other in an angle a formed between each of the elongate arms and a vertical reference plane 123 which comprises the pivoting axis of the handle. A center of the pivot connection, through which the pivoting axis passes, is schematically designated as 125 and is referred to herewith as a “pivot point”.

As further shown in FIG. 1, handle 111 is pivotable between a first, carrying position designated as P1 and a second, storage position designated as P2. In position P2, the handle is at a reclined position, for example, with the grasping portion extending behind the back rest of the seat.

An angle formed between the elongate arm(s) and the reference plane at the carrying position may be from within the range of 0-20, 0-30, 0 -40 degrees or intermediate, larger or smaller angle. In other embodiments, the elongate arm(s) may extend beyond the reference plane, forming a negative angle with the reference plane, for example an angle of −10 degrees, −20 degrees, −30 degrees or intermediate, larger or smaller angle.

An angle formed between the elongate arm(s) and the reference plane at the storage position may be from within the range of 45-90, 50-80, 45-75 degrees or intermediate, larger or smaller angle.

Generally, the handle can be associated with a distance adjusting mechanism which provides for changing a distance between the grasping portion of the handle, and the pivot point.

Lengthening of the distance via the distance adjusting mechanism can enable the handle (at least the grasping portion thereof) to extend sufficiently outwardly when pivoted to the storage position behind the backrest, such as behind a position in which a seated infant's head would be located. Extending the handle to a position behind the backrest may be advantageous, for example, when the safety seat is used as a rearwards facing car seat and is placed on a front seat of the vehicle, since the extended handle does not interfere, or only least interferes, with the driver's view.

Shortening of the distance via the distance adjusting mechanism can enable approximating the grasping portion of the handle closer to the pivot point. In such configuration, the shorter distance between the grasping portion and the pivot point may facilitate carrying the carrier, and would further enable holding the seated infant closer to the user arm during carrying (as opposed to, for example, holding the seated infant closer to the ground).

An extent to which the distance between the grasping portion and the pivot point changes can be restricted so that the handle (or any other parts of the safety seat) would not protrude beyond a notional predefined envelope, e.g. as defined in applicable regulations and/or standards, such as according to Regulation No. 129 (“Uniform provisions concerning the approval of enhanced Child Restraint Systems used on board of motor vehicles (ECRS)”. By maintaining the handle within a volume defined by the envelope, it can be ensured that the handle does not reach or bump into car portions like the car roof, for example, when the carrier is mounted within the car.

In the shown example, a distance “r” between the grasping portion of the handle (which extends from distal end 117 of the elongate arm) and the pivot point can be lengthened or shortened by the distance adjusting mechanism. The range of pivoting of the handle and the variations in distance are limited so that the handle would not extend beyond the envelope 127. As shown, in the two end positions of the handle and in between those positions, a height “h”, defined for example along a plane which is perpendicular to reference plane 123 and includes the pivot point, is not surpassed.

In use, adjustment of the handle position can be performed, for example, before insertion of the carrier into a car; following insertion of the carrier into the car; before removal of the carrier from the car; after the carrier had been removed from the car, and/or at other times. Adjustment of the handle may be performed for placing the handle at a position suitable for carrying the carrier, for placing the handle at a position in which the handle is stored, e.g. extends at least partially behind the backrest, for placing the handle at a midway position, and as such.

The handle can be locked to remain stationary at least at the extreme positions, i.e. the carrying position and the storage position, for example via lock mechanism(s) as described herein. Optionally, the handle can be locked at midway positions.

For adjusting the handle, the user can hold or contact the grasping portion and apply force onto it, such as by pushing or pulling on the grasping portion towards or away from the backrest of the seat. As the handle pivots, the distance adjusting mechanism is actuated, causing lengthening or shortening of the distance, depending on the direction of pivoting.

It is noted that pivoting of the handle may be carried out manually, for example, by a user puling or pushing on at least a portion of the handle such as the grasping portion. Additionally or alternatively, pivoting of the handle may be carried out automatically, for example with the aid of one or more motors, such as linear motors, pneumatic motors, rotational motors, and/or other suitable motors. In some cases, a lightweight motor is selected so as to least affect the total weight of the carrier.

In some cases, initiation of pivoting may be carried out manually, and pivoting itself is then carried out automatically. Manual initiation of pivoting can be achieved, for example, with the press of button, by manual release of a lock, by applying of pushing/pulling force onto the grasping portion, or others.

The distance adjustment mechanism can be actuated by pivoting of the handle, simultaneously therewith. In some cases, the distance adjusting mechanism can be actuated by the pivoting, for example such that at least partial pivoting is carried out first, and the change in distance follows. In some cases, the distance adjusting mechanism can be actuated only once at least partial pivoting has taken place. For example, at least partial pivoting of the handle may release a lock that prevents longitudinal extension of the handle, or release a lock that prevents repositioning of the handle on a longitudinal axis passing along the handle. In some cases, the distance adjusting mechanism can be operable to change the distance along only along a partial pivoting angle, and not along the full extent of pivoting angle of the handle. Alternatively, the distance adjusting mechanism can be operable along the full extent of pivoting of the handle, such that the change in distance accompanies occurs throughout the full range of pivoting.

A change in the distance between the grasping portion and the pivot point may be carried out in various manners. In one example, the handle housing can be displaced relative to the pivot point, thereby distancing or approximating the grasping portion of the handle from the pivot point. In another example, at least a portion of the handle, such as a telescopic portion, can be extended or shortened, thereby distancing or approximating the grasping portion of the handle from the pivot point. Optionally, the change in distance can be incremental, for example, carried out at predefined intervals.

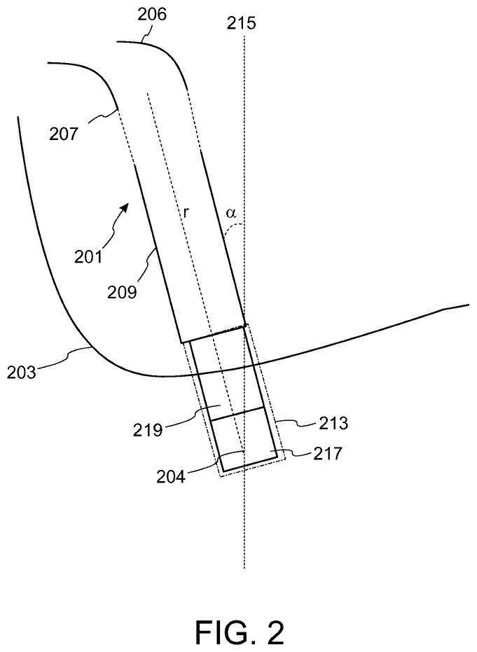

FIG. 2 is a schematic side view illustration of a handle of an infant carrier, in accordance with an example of the presently disclosed subject matter.

In the example of FIG. 2, a handle 201 (one side thereof is shown) is connected to a seat 203 of the carrier at a pivot connection, defining a central pivot point 204. A grasping portion 206 of the handle extends from a distal end 207 of an elongate arm 209 of the handle. A distance between the grasping portion and the pivot point is designated as “r”.

Generally located at or adjacent a proximal end of the handle, a distance adjusting mechanism 213 is configured to change distance “r” during and/or as a result of pivoting of the handle, such as in one of the above described manners. When the handle is pivoted, an angle a between the elongate arm and a vertical reference plane 215 changes, for example, increases when the handle is pivoted to the storage position, and decreases when the handle is pivoted to the carrying position.

Distance adjusting mechanism 213 is generally comprised of a seat connection component 217, and a handle connection component 219. The seat connection component and the handle component are engaged to each other in a manner in which movement of at least one of the components relative to the other produces the change in distance “r”. In some embodiments, the seat connection component is stationary and fixed to the seat (e.g. to a side wall of the seat) and the handle connection component is attached to the elongate arm of the handle or constitutes a part thereof.

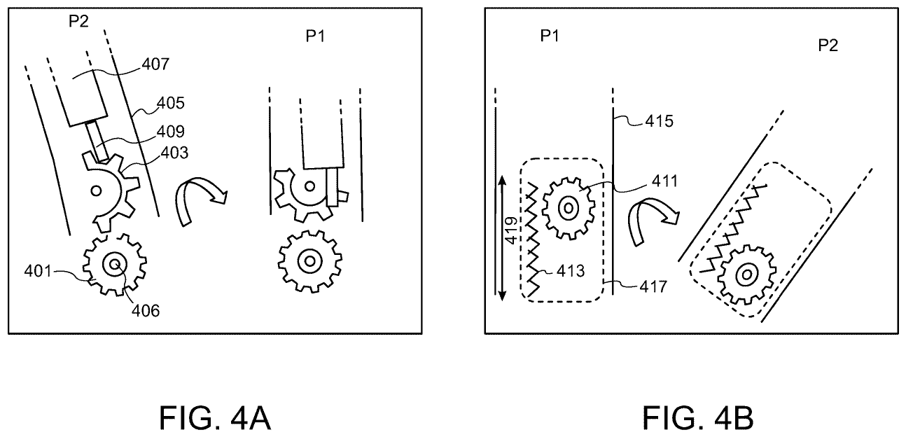

Relative movement between the handle connection component and the seat connection component can be generated when the elongate arm is pivoted, carrying the handle connection component along with it, thereby moving the handle connection component with respect to the stationary seat connection component. Movement of the handle connection component then changes distance “r” in one of various manners, including, for example, pushing/retracting a telescopic portion of the elongate arm, or changing a relative position of the elongate arm housing as whole relative to the pivot point, for example as further described in FIGS. 4A-B below.

The handle connection component can be mounted or otherwise connected to the elongate arm (such as to the elongate arm housing) in a manner that allows at least some freedom of movement for the handle connection component, for example, a pivot attachment that enables rotation of the handle connection component, optionally inside the elongate arm housing.

The seat connection component can have an at least partially rounded profile so that a housing of the elongate arm can be positioned to rotate about the seat connection component. In an example, the housing comprises a circular (or otherwise rounded) recess in which the rounded seat connection component is received.

In some embodiments, the carrier handle can include a telescopic structure, for example, the handle comprises at least one first portion that is telescopically extendible or retractable relative to at least one second portion of the handle. Optionally, the handle can include multiple telescopic portions, e.g. at least two, at least three, at least four telescopic portions in which a portion is at least partially nested within another portion. The telescopic portions can be incorporated as part of the elongate arm(s) of the handle. Optionally, the elongate arm can be constructed, as a whole, of telescopic portions.

In operation, pivoting of the handle can actuate advancement of the telescopic portion(s) distally or retraction thereof proximally, depending on the direction of pivoting. In an example of two portions: when lengthening the distance between the handle grasping portion and the pivot point, for example so as to allow at least the grasping portion to reach behind the backrest of the seat, the telescopic first portion may be advanced distally outwardly relative to the second portion; for shortening the distance between the handle grasping portion and the pivot point, the telescopic first portion may be retracted proximally towards the second portion.

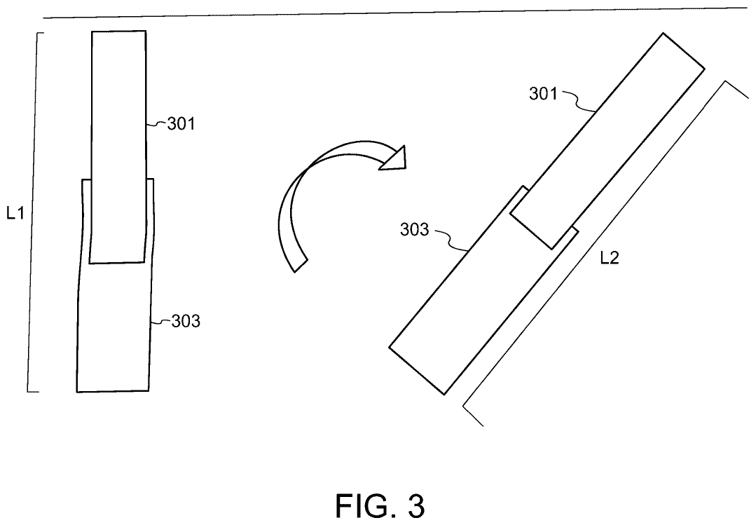

FIG. 3 is a schematic illustration of a telescopic structure which can be used in a handle, in accordance with the presently disclosed subject matter.

As shown in FIG. 3, the first telescopic portion of the handle is designated as 301; the second portion of the handle is designated as 303. In position P1, the carrying position, telescopic first portion 301 is at least partially received within second portion 303. A total length of the portions together is designated as L1. In position P2, the storage position, telescopic first portion 301 is advanced distally and further outwardly from the second portion 303, so that a total length of the portions together L2 is longer than length L1 (L2>L1). The increased total length may provide for placing at least the grasping portion of the handle (which is connected at the distal end of the elongate arm) behind the backrest of the seat.

It is noted that the first telescopic portion, the second portion (and optionally additional telescopically structured portions of the handle) can be constructed as elongate segments, shafts, cylinders, tubes and/or other suitable elongate structure configured to be at least partially received within a sequential portion. The telescopic mechanism can involve a more distal portion being at least partially nested within a more proximal portion; or vice versa, a more proximal portion being at least partially nested within a more distal portion.

In general, adjustment of the distance between the grasping portion of the handle and the pivot point can be carried out as a function of relative movement between at least one component that constitutes a part of handle, e.g. a part of the handle elongate arm, and at least one component that constitutes a part of the seat, for example as part of the pivot connection at which the handle is attached to the seat (e.g. to the side wall of the seat). Optionally, one of the components, such as the seat component, can remain fixed in place, while the other component, the handle connection component, can move (e.g. slides, rotates, pivots) about the fixed component. Alternatively, both components can move (e.g. rotate).

Movement of the handle connection component can be produced as a direct or indirect result of pivoting motion of the elongate arm, to which the handle connection component is coupled. In some embodiments, pivoting motion of the elongate arm is translated, via the handle connection component, into linear motion of at least a portion of the elongate arm, allowing to lengthen or shorten the distance between the handle grasping portion and the pivot point.

The handle connection component and the seat connection component of a distance adjusting mechanism can include elements shaped to engage each other in a manner suitable for transferring force, such as torque, from one component to the other. For example, the seat and handle connection components may each include at least one ridge and dent for meshing with each other at an area in which the components interface. The components can be formed as toothed elements such as a gear, a partially toothed gear, a rack, and as such.

The seat connection component can be generally constructed and located such that the elongate arm is pivoted about it, with the handle pivot axis passing at a center of the seat connection component (the pivot point).

FIGS. 4A-B are schematic illustrations of distance adjusting mechanisms which can be used with a handle, in accordance with the presently disclosed subject matter.

In the example of FIG. 4A, a toothed element 401 (also referred to as “pivot connection toothed element” or generally as “seat connection component”), constituting a part of the pivot connection and having the handle pivot point 406 as its center, remains fixed in place, while another toothed element 403 (also referred to as “arm toothed element” or generally as “handle connection component”), constituting a part of the elongate arm 405, is meshed with pivot connection toothed element 401 and is configured to turn about pivot connection toothed element 401. Turning of arm toothed element 403 is produced as the arm toothed element is coupled to elongate arm 405, for example to an inner wall of the elongate arm housing, which is moved when the elongate arm is pivoted.

A telescopic portion 407 of the elongate arm is connected to arm toothed element 403 by a lever 409 extending from arm toothed element 403 to telescopic portion 407, as shown. In other embodiments, the telescopic portion can be connected to the arm toothed element directly, for example by a fixation, a recess and respective protrusion, and the like.

In operation, when elongate arm 405 pivots, arm toothed element 403 turns about pivot connection toothed element 401, thereby pushing telescopic portion 407 distally (thus lengthening the distance, see position P2) or pulling telescopic portion 407 proximally (thus shortening the distance, see position P1). The push or pull action of the telescopic portion is determined by a direction of pivoting of the elongate arm.

In the example shown, arm toothed element 403 is only partially toothed, comprising teeth extending only partially along the perimeter of the element. Rotation of the toothed element to a certain extent (in the example shown, of up to 40 degrees) would advance telescopic portion 407 (by pushing lever 409); rotation of the toothed element to a higher extent (more than 40 degrees) would retract telescopic portion 407 (by pulling on lever 409). In the example of a fully toothed element, rotation of up to 180 degrees would advance the telescopic portion, while rotation of between 180-360 degrees would retract the telescopic portion.

In the example of FIG. 4B, a pivot connection toothed element 411 (also generally referred to as “seat connection component”) remains fixed in position, while an arm toothed element 413 (also generally referred to as “handle connection component”), in this case formed as a rack (a linear arrangement of teeth), is meshed with the pivot connection toothed element and travels along the pivot connection toothed element when the handle elongate arm 415 is pivoted. The rack extends along at least a portion of an inner wall of a recess 417 formed at a proximal area of a housing of the elongate arm. In use, when the elongate arm is pivoted and the rack moves relative to pivot connection toothed element 411, the elongate arm is repositioned, as a whole, relative to the pivot connection, so that a grasping portion of the handle (not shown, generally connected at a distal end of the elongate arm) is placed at a different distance relative to the pivot point.

A maximal extent in which the elongate arm can be moved is determined, in this case, by an axial length 419 of the rack. Therefore, an axial length of the rack may be selected according to a desired change in the distance of the grasping portion of the handle relative to the pivot point.

Adjustment of the carrier handle between different positions relative to the seat can be accompanied by the change in distance between the handle grasping portion and the handle pivot point. The change in distance can involve, in some cases, linear movement (advancement and retraction) of a portion of the handle, optionally, a telescopic portion. In an example, linear movement can be produced by turning of an arm toothed element about a pivot connection toothed element, with the telescopic portion being connected, at its proximal end, to the arm toothed element, and moved linearly (advanced or retracted) by rotation of the arm toothed element.

The arm toothed element can be coupled to a proximal portion of the elongate arm of the handle, for example, fixed to an internal wall of a housing of elongate arm, so that when the elongate arm pivots, the arm toothed element is carried along, and is caused to rotate about the pivot connection toothed element.

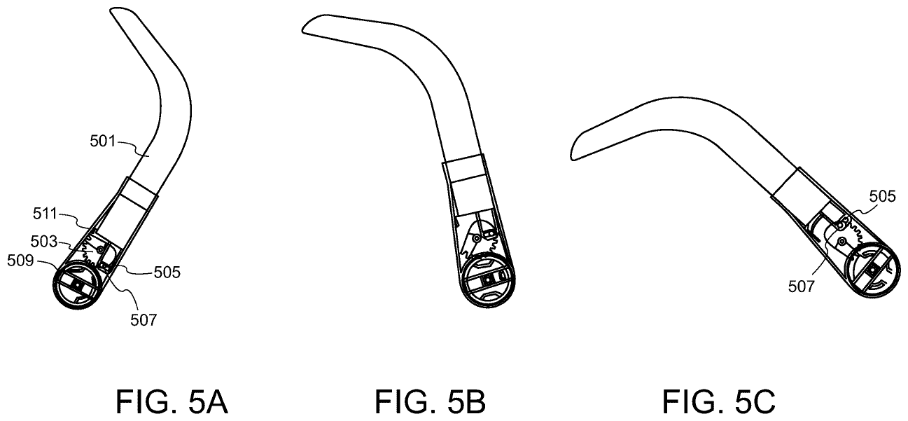

FIGS. 5A-C are longitudinal cross-sectional views of a handle including a distance adjusting mechanism of the kind described in FIG. 4A, in accordance with a further example of the presently disclosed subject matter, in three different states of the mechanism, respectively.

The three states shown in the figures include an initial state (optionally, corresponding to a carrying position of the handle)—FIG. 5A; a middle state—FIG. 5B, and an end state, (optionally, corresponding to a storage position of the handle)—FIG. 5C, all shown at a longitudinal cross section view.

In this example, the telescopic portion of the handle, designated as 501, is connected to the arm toothed element 503 by having a recess 505 formed at the telescopic portion proximal end, which is fitted and held on a respective protrusion 507 formed at the surface of the arm toothed element. Other embodiments may include any suitable fixation or mounting rigidly coupling the telescopic portion proximal end to the arm toothed element.

As shown, the teeth of the arm toothed element are meshed, in part, with the teeth of the pivot connection toothed element 509, so that the arm toothed element is configured to turn about the pivot connection toothed element, as an area of engagement between the teeth moves.

A housing of the elongate arm, at a proximal portion thereof, is rotatably positioned on the pivot connection toothed element. As shown, housing 511 includes a rounded recess in which pivot connection toothed element 509 is received.

The arm toothed element is coupled to housing 511 (as shown in this example, the coupling is at a center of rotation of the arm toothed element) so that in operation rotation of the elongate arm housing about the pivot connection toothed element carries the arm toothed element along, causing it to turn, at least partially, about the pivot connection toothed element. As the arm toothed element turns, the attachment between the telescopic portion and the arm toothed element moves, thereby advancing or retracting the telescopic portion relative to the housing.

In FIG. 5A, the attachment between the telescopic portion and the arm toothed element is closest to the pivot connection toothed element (and therefore closest to the pivot point of the handle as a whole); and in FIG. 5C, the attachment between the telescopic portion and the arm toothed element is farthest from the pivot connection toothed element (and therefore farthest the pivot point of the handle as a whole).

As mentioned above, the carrier handle can include or be operably connected to one or more lock mechanisms which prevent undesired pivoting of the handle and/or prevent an undesired change in the distance between the grasping point and the pivot point of the handle. In some cases, by restricting (or fully preventing) pivoting, the change in distance can be restricted (or prevented) as well.

Preventing undesired pivoting of the handle and/or undesired lengthening of the handle and/or undesired repositioning of the handle (such as relative to the pivot point) may be advantageous for safety reasons, for example so that the handle remains stationary when carrying the carrier with an infant seated therein.

In some embodiments, a lock mechanism can be constructed and positioned to allow a user to operably engage the lock from an external side of the handle (e.g. from an external surface of the handle housing). Optionally, operably engaging the lock can involve pushing or otherwise applying manual force by the user to selectively release the lock.

In some cases, a locking element of a lock mechanism can extend from the pivotable handle to a stationary component or area, such as areas located externally to the handle, e.g. at the side wall of the seat.

In operation, a user may selectively release the lock when adjusting the handle. Optionally, the lock is configured to automatically return to a locking state once released. In some cases, returning of the lock to the locking state can be spring-actuated.

In some embodiments, the lock mechanism can be configured such that only when the handle is engaged on its opposing sides, for example manually by a user which presses onto the opposing locks with both of his hands, locking is released and pivoting is enabled.

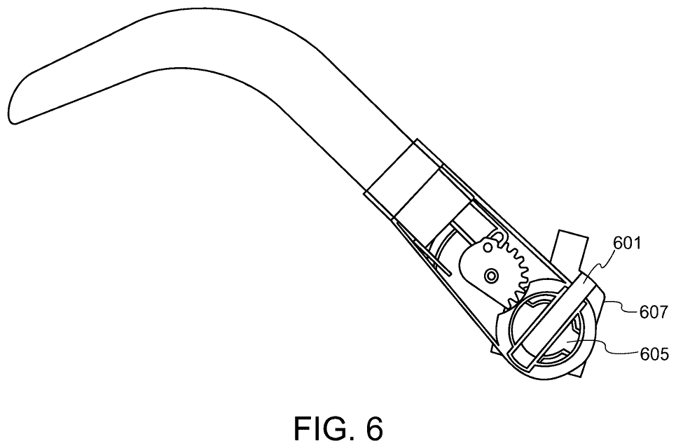

FIG. 6 is a cross-sectional view of a handle comprising a lock mechanism, in accordance with a further example of the presently disclosed subject matter.

In the example shown, a locking element is in the form of a push pin 601 which extends between a proximal portion of the elongate arm housing, such as within a designated slot extending at least partially across a recess 605 of the handle housing, and an adaptor 607 which holds the pivot connection toothed element to the seat. When the push pin extends between the housing and the adaptor, movement of the handle relative to the seat is prevented; and only when the push pin is advanced fully into its designated slot within the housing, movement (pivoting) of the handle can take place.

It is noted that additional and/or other lock mechanisms may be implemented for restricting pivoting of the handle and/or for restricting the change in distance. In an example, a lock mechanism positioned at an interface between a telescopic portion of the handle and another handle portion which the telescopic portion moves relative to, would limit (optionally, prevent) linear advancement or retraction of the telescopic portion. In some embodiments, a lock mechanism may include an automatic lock or stop such as an electromagnetic lock.

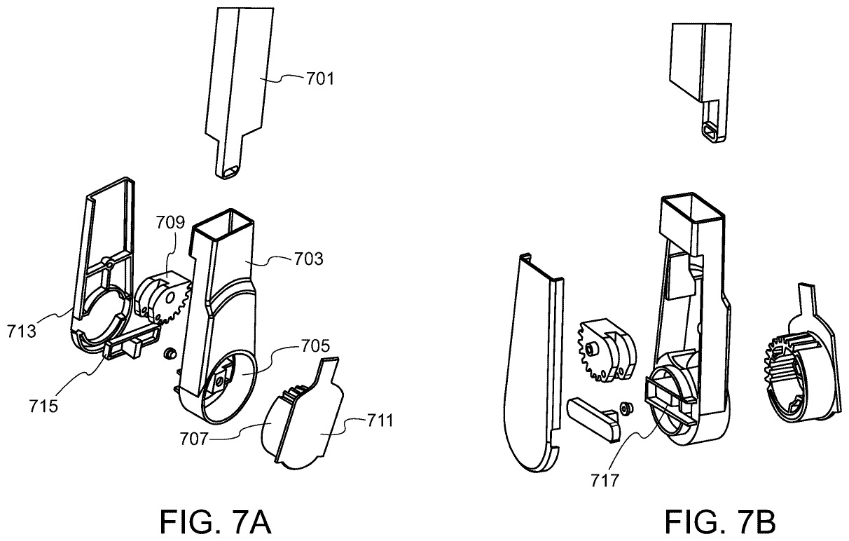

FIGS. 7A-B are exploded views of a proximal portion of a handle including a distance adjusting mechanism of the kind described in FIG. 4A, and a lock mechanism of the kind described in FIG. 6, in accordance with a further example of the presently disclosed subject matter.

In the exploded views, the telescopic portion of the handle is designated as 701. The housing of the handle, in this example being a handle portion which the telescopic portion moves relative to, is designated as 703. A rounded recess 705 formed in the handle housing is rotatably positioned over a pivot connection toothed element 707. An arm toothed element 709 is configured to fit within the housing, attached to an inner wall of the housing. An external cover of the housing is designated as 713.

As further shown, the pivot connection toothed element 707 is integrally attached to an adaptor 711, which in turn is attachable to the seat of the carrier (seat not shown).

A lock mechanism of the present example includes a push pin 715, which is at least partially received within a designated slot 717 (shown best in FIG. 7B), the slot defined by walls which extend across rounded recess 705 of the elongate arm housing.

As mentioned above, adjustment of the carrier handle between different positions can be accompanied by the change in distance between the handle grasping portion and the handle pivot point. The change in distance can involve, in some cases, repositioning of the handle along a linear axis. Repositioning can involve placing of the handle housing at a plurality of positions that differ from each other in a distance measured between the distal end of the elongate arm of the handle (where the grasping portion begins) and the pivot point.

In some cases, repositioning of the handle can be achieved by movement of a handle connection component relative to a seat connection component. In an example, the handle connection component can be in the form of a linear rack of teeth which move relative to a fixed seat connection component in the form of gear or a partially toothed gear. The linear rack of teeth can be constructed as part of a proximal recess formed in the housing of the elongate arm at the pivot connection, so that pivoting of the handle's elongate arm about the gear, which is meshed with the rack, can cause the rack to travel up or down during pivoting of the elongate arm housing.

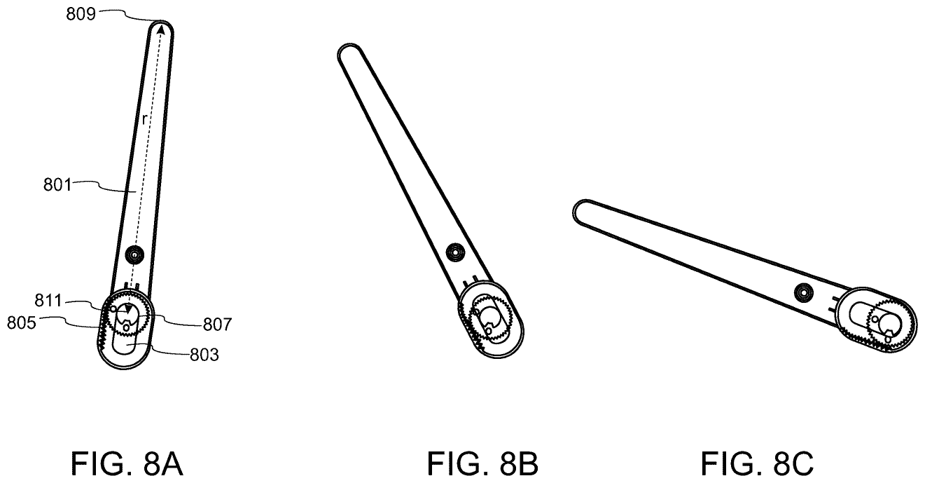

FIGS. 8A-C are longitudinal cross-sectional views of a handle comprising a distance adjusting mechanism of the kind described in FIG. 4B, in accordance with a further example the presently disclosed subject matter, in three different states of the mechanism, respectively.

The three states shown in the figures include an initial state (optionally, corresponding to a carrying position of the handle)—FIG. 8A; a middle state—FIG. 8B, and an end state, (optionally, corresponding to a storage position of the handle)—FIG. 8C, all shown at a longitudinal cross section view.

In the present example, a housing 801 of the elongate arm is shown to include a proximal recess 803. A linear rack of teeth 805 extends along an inner wall of the housing at the position of the recess, where at least some of the teeth are meshed with the teeth of the pivot connection toothed element 807 (also generally referred to as “seat connection component”). A distance between a distal end 809 of the elongate arm and the pivot point 811 (centrally located with respect to the pivot connection toothed element) is designated as r2. As can be observed, distance r2 increases as the handle is pivoted form the initial position (FIG. 8A) to the end position (FIG. 8C).

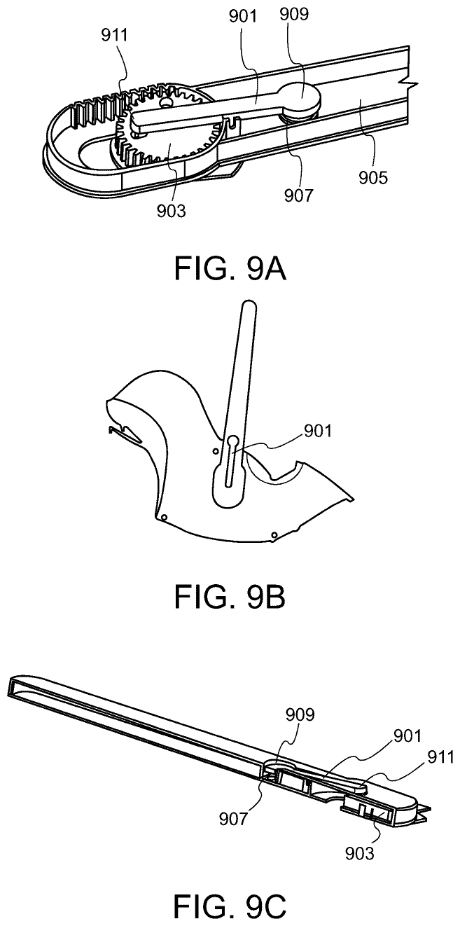

FIG. 9A isa perspective view of a proximal portion of a handle comprising a lock mechanism used with the exemplary distance adjusting mechanism of FIG. 4B, also appearing in FIGS. 8A-C, in accordance with a further example of the presently disclosed subject matter.

In the example shown, a locking element in the form of a push pin 901 extends between the pivot connection toothed element 903 and the elongate arm housing 905, such that in a locked state the pin prevents movement of the housing relative to the pivot connection toothed element, thereby preventing pivoting of the handle. As can be observed, push pin 901 is mounted, at its handle end 909, onto a spring 907. The push pin is engageable from externally to the handle housing so that pressure applied onto the pin by a user pushes the handle end of the pin against the spring, which in turn compresses under the pressure, such that the opposite end of the pin 911 is at least partially lifted upwards from the pivot connection toothed element. Once end 911 is lifted, movement of the elongate arm housing relative to the pivot connection toothed element is no longer restricted.

In the cross-section view of FIG. 9C, end 911 of the pin is shown to be lifted off the toothed element, while end 909 is pushed down against the spring. In this manner, locking of the toothed element is released. In some embodiments, a coupling between end 911 and the toothed element is an interference coupling, for example including a projection of the pin (not shown) which is removably received within a respective recess formed in the toothed element (recess not shown).

FIG. 9B is a side view of an infant carrier comprising a handle of the kind shown in FIG. 9A, in accordance with a further example of the presently disclosed subject matter.

In FIG. 9B, push pin 901 is shown to extend to an external surface of the elongate arm housing, so as to be engaged manually by a user.

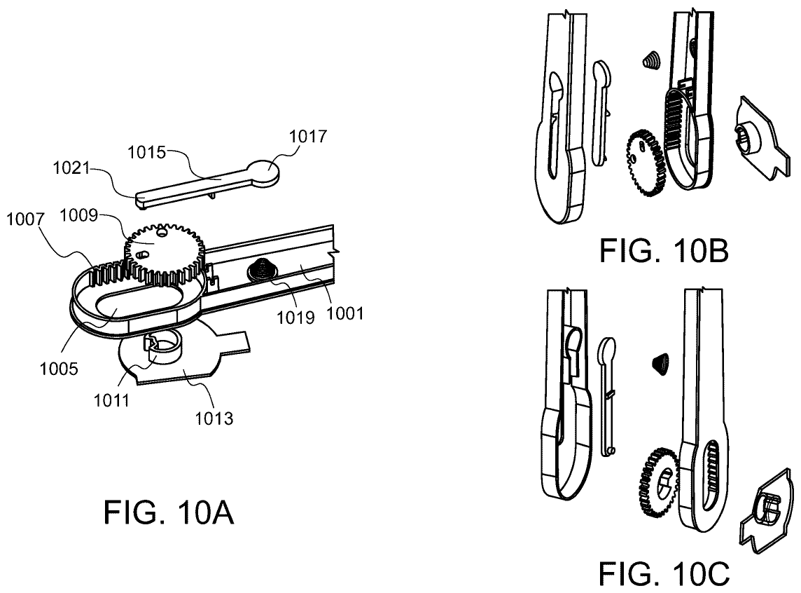

FIG. 10A is an exploded view of a proximal portion of a handle without an external cover of a housing thereof, the handle comprising a distance adjusting mechanism of the kind shown in FIG. 4B, in accordance with a further example of the presently disclosed subject matter; FIGS. 10B and 10C are exploded views of the proximal portion of a handle shown in FIG. 10A including the external cover of the housing.

As shown, a housing 1001 of the elongate arm, at a proximal portion thereof, defines a recess 1005. A linear rack 1007, constituting the arm toothed element, extends along at least a part of an inner wall of the recess. A gear 1009, constituting the pivot connection toothed element, is structured to fit onto or be received on a protrusion 1011 of an adaptor 1013 which in turn is connected to the seat (for example, to the side wall of the seat, not shown). The gear is sized to fit within the recess so that it at least partially meshes with the rack.

A lock mechanism, as further shown, includes a push pin 1015 located so that a distal end of the pin 1017 is mounted on a spring 1019, and a proximal end 1021 of the pin is detachably coupled to the gear.

A carrier described above as well as any carrier according to the presently disclosed subject matter, can comprise, at its pivot connection to the handle, a pivot connection toothed element (also generally referred to as “seat connection component”). When a housing of the handle (and more specifically, of the elongate arm of the handle) pivots, an arm toothed element (also generally referred to as “handle connection component”), which is attached to the elongate arm housing and also at least partially meshed with the pivot connection toothed element, can move about the pivot connection toothed element.

The pivot connection toothed element can be fixed to the frame of the seat, for example to a side wall of the seat. Optionally, the pivot connection toothed element is held to the seat via an adaptor which is coupled to (or forms a part of) the side wall of the seat.

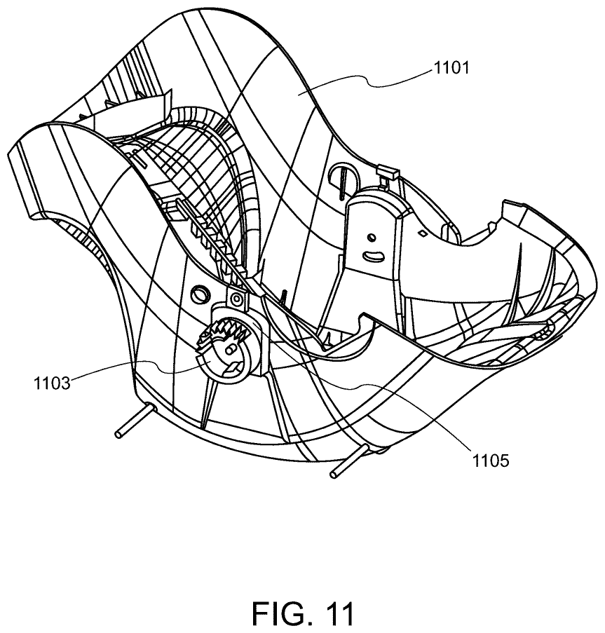

FIG. 11 is a perspective view of an infant carrier frame with a seat connection component via which a handle can be connected to the frame, in accordance with an example of the presently disclosed subject matter.

In the present figure, the frame of the seat is designated as 1101; the pivot connection toothed element, which in this example includes teeth along only a part of its circumference, is designated as 1103; the adaptor is designated as 1105.

It should be understood that distance adjusting mechanisms described above are provided as non-limiting examples of such mechanism, and other solutions can be implemented for changing a distance between the distal end of elongate arms and the handle pivoting axis. For example, the handle of the infant carrier can be structured and configured so that the change in distance between the handle grasping portion and the handle pivot axis can be achieved with the aid of push/pull elements. Examples of push/pull elements can include a spring, a cable, a rotatable belt, and/or other elastic elements suitable for distancing and/or approximating a part of the handle to which they are connected, when their movement is actuated by pivoting of the handle. The push/pull elements can be used, for example, in a handle in which the elongate arms are telescopic, each elongate arm having a distal portion that is movable with respect to a proximal portion of the arm. In an exemplary handle structure, a push spring can extend between the distal and proximal portions of the elongate arm; and a pulling cable can be at least partially coiled around the seat connection component and connected on its other end to the distal portion of the elongate arm. Pivoting of the handle can uncoil the table, allowing the push spring to extend and thereby to advance the distal portion of the elongate arm distally. Similarly, pivoting of the handle in the other direction can coil the cable around the seat connection component, pulling back on the spring to thereby approximate the distal portion proximally. In another exemplary structure which includes a push/pull element, a belt can be situated longitudinally to encircle both the seat connection component and a protrusion defined in the distal portion of the arm. Pivoting of the handle can rotate the belt which in turn would drag the distal portion along, thereby distancing or approximating the distal portion, depending on the direction of pivoting.

In other embodiments, the handle of the infant carrier can be configured so that the change in distance between the handle grasping portion and the handle pivot axis can be achieved with the aid of a bendable joint which connects between two sequential portions or segments of the elongate arm, and a connecting element as detailed below, where both the bendable joint and the connecting element constituting, in this case, a part of a distance adjusting mechanism. A bending angle of the joint can be increased or reduced by the pivoting, resulting in a change to the distance between the grasping portion and the pivot axis. For distancing the grasping portion of the handle, the bending angle can be increased, and for approximating the grasping portion of the handle, the bending angle can be reduced. The handle can be structured to provide for the change in the bending angle of the joint by having one or more connecting elements located or extending between the seat connection component and the bendable joint, such as to be actuatable to move the bendable joint when the proximal portion of the arm is pivoted about the seat connection component Examples of connecting elements can include: a connecting bar which extends between the seat connection component and the bendable joint, and can drag the joint along when pivoted; a band which encircles both the seat connection component and a protrusion located at the bendable joint, and can drag the joint along when rotated due to pivoting of the proximal portion of the elongate arm; a gear train situated along the length of the proximal portion of the arm, where the gear train can be actuated by pivoting of the housing of the proximal portion; rotation of the gears constituting the gear train can result, at a distal end of the gear train, in bending of the bendable joint. In general, the connecting element can be provided in addition to the elongate arm, and can extend along the proximal portion of the arm, for example inside a housing of the proximal portion or adjacent thereto, between the seat connection component (at the pivot connection of the handle) and the bendable joint. A potential advantage of a handle in which each of the elongate arms is constructed of two or more portions (such as two or more sequential segments) coupled to each other by a bendable joint may include the ability to fold the elongate arm by bending the joint, enabling, for example, a more compact storage configuration of the infant carrier.

1. An infant carrier configured to constitute a part of a safety car seat, the infant carrier comprising:
a seat shaped to accommodate an infant; the seat comprising a seating portion, side walls extending upwards from the seating portion, and a back rest;
a handle comprising:
two elongate arms, each arm having a distal end and a proximal end, with a proximal portion of the arm defined adjacent the proximal end and a distal portion of the arm defined adjacent the distal end; and
a grasping portion extending between the distal ends of the arms;
pivot connections via which the proximal ends of the arms are pivotably mounted to said side walls so as to enable pivoting of the arms together with the grasping portion about a handle pivoting axis; the handle being pivotable between at least a first position and a second position which differ in an angle formed by at least the proximal portion of each of the elongate arms with a vertical reference plane comprising the handle pivoting axis; and
a distance adjusting mechanism operably connected to each of the elongate arms and located, at least in part, at the corresponding pivot connection so that pivoting of the arms about said pivot connection actuates said mechanism to change a distance between the distal end of each of said elongate arms and said handle pivoting axis.

2. The infant carrier according to claim 1, wherein said distance adjusting mechanism is configured so that the pivoting and the change of said distance take place simultaneously.

3. The infant carrier according to claim wherein said distance adjusting mechanism is configured to change said distance incrementally and so that the distance changes with the change of said angle.

4. The infant carrier according to claim 1, wherein said distance adjusting mechanism is configured so that said change in distance is actuated for at least a portion of a total angle along which said handle is pivoted.

5. The infant carrier according to claim 1, wherein said angle in the first position is smaller than in the second position.

6. The infant carrier according to claim 1, wherein said first position of the handle is a carrying position and said second position of the handle is a storage position.

7. The infant carrier according to claim 6, wherein at the second position, said grasping portion is spaced from the reference plane to a distance greater than a distance between the back rest and the reference plane.

8. The infant carrier according to claim 7, wherein at said second position said distance between the distal end of each of said elongate arms and its corresponding pivot joint, is greater than at said first position.

9. The infant carrier according to claim 1, comprising a lock mechanism for restricting pivoting of the handle at least in the first position and/or in the second position, the lock mechanism configured to be released when pivoting of the handle is desired.

10. The infant carrier according to claim 1, wherein in the first position of the handle said distance between the distal end of each of said elongate arms and its corresponding pivot connection at least does not exceed a distance between the reference plane and an area of the backrest most remote from the reference plane.

11. The infant carrier according claim 1, wherein said distance adjusting mechanism comprises:
a seat connection component positioned such that said handle pivot axis extends through its center, and
at least one handle connection component which is in direct or indirect engagement with said seat connection component for transferring pivoting motion of said handle into movement of at least a part of the elongate arm, wherein the at least a part of the elongate arm is coupled to or includes the handle connection component.

12. The infant carrier according to claim 11, wherein said seat connection component is fixed in position and is free of an ability to pivot or rotate.

13. The infant carrier according to claim 11, or wherein the seat connection component is at least partially rounded so that at least the proximal portion of said elongate arm is rotatably positioned around the seat connection component.

14. (canceled)

15. The infant carrier according to claim 11, wherein said seat connection component is formed as an at least partially toothed element and said handle connection component is formed as an at least partially toothed element, said at least partially toothed elements being at least partially meshed with each other.

16. The infant carrier according to claim 15, wherein said handle connection component is rotatable about a handle connection component pivoting axis which is different than the handle pivoting axis, the plurality of teeth of said handle connection component being located at different distances from the handle connection component pivoting axis.

17. The infant carrier according to claim 1, wherein the proximal portion and the distal portion of each elongate arm are integrally formed as a single unit.

18. (canceled)

19. The infant carrier according to claim 1, wherein the proximal portion and the distal portion are arranged so that pivoting of the elongate arm changes their position with respect to each other.

20. (canceled)

21. The infant carrier according to claim 1, wherein the distance adjusting mechanism is operable to transfer pivoting motion of the elongate arm at said pivot connection into linear movement of at least a part of the elongate arm.

22. A kit comprising:
an infant carrier according to claim 1; and
a base mountable onto a car seat, the infant carrier configured to be mounted onto said base.

23. The kit according to claim 22, wherein said base and said infant carrier, inclusive of the handle at both the first and second positions and in between said positions, are sized to fit within an enveloping volume as defined by Regulation No. 129 of the Economic Commission for Europe of the United Nations entitled “Uniform provisions concerning the approval of enhanced Child Restraint Systems used on board of motor vehicles (ECRS)”.
